(19) United States
(12) Patent Application Publication
(10) Pub. No.: US 2019/0347732 A1
(43) Pub. Date: Nov. 14, 2019

(54) SYSTEM AND METHOD FOR PROVIDING A MAXIMUM DIVERSIFICATION PORTFOLIO

(71) Applicant: Murray Hill Capital Group LLC, New York, NY (US)

(72) Inventors: Leonard Song, Riverdale, NY (US); Hao Guo, Riverdale, NY (US); Gongchen Zhang, Hoboken, NJ (US); Yunshu Wang, New York, NY (US); Lauren Song, Riverdale, NY (US)

(21) Appl. No.: 15/977,272

(22) Filed: May 11, 2018

(51) Int. Cl. G06Q 40/06; G06Q 40/04; G06Q 40/08

(52) U.S. Cl. CPC G06Q 40/06; G06Q 40/08; G06Q 40/04

(57) ABSTRACT

Methods and systems for generating a diversification indicator for a portfolio are disclosed. A plurality of assets within the portfolio are identified, each of the plurality of assets having a corresponding testing weight value and a corresponding volatility value. An overall volatility value of the portfolio is identified. A diversification indicator is computed based on the overall volatility value and corresponding testing weight and volatility values of each of the plurality of assets. A maximum diversification indicator is identified from diversification indicators based on testing weight values. The portfolio corresponding to the maximum diversification indicator is transmitted to a client computing device.

### TECHNICAL FIELD

Embodiments of the invention relate generally to investment portfolio management and, more specifically, to providing a diversification indicator and determining maximum diversification in a portfolio of financial instruments.

### BACKGROUND

In finance, the concept of diversification is applied to investment portfolios to mitigate risks of individual investment assets. A well-diversified portfolio will often have less overall risk than the weighted average risk of its constituent assets, and often less risk than the least risky of its constituent. Various strategies have been used to create highly diversified portfolios, yet determining the optimal balance of assets to achieve this is not straightforward.

When different assets are not uniformly uncorrelated, a weighting approach to asset allocation that accounts for their relative correlations can help to maximize the diversification. However, such methods are generally not applicable across different asset classes. In addition, these methods produce unbounded outcomes, making it difficult to compare different portfolios.

### BRIEF DESCRIPTION OF THE DRAWINGS

The present invention is illustrated by way of example, and not by way of limitation, and will become apparent upon consideration of the following detailed description, taken in conjunction with the accompanying drawings, in which like reference characters refer to like parts throughout, and in which:

FIG. 1 is a block diagram illustrating an exemplary computer network in which embodiments of the present invention may operate;

FIG. 2 is a block diagram illustrating an exemplary diversification optimization platform in accordance with an embodiment of the invention;

FIG. 3 is a flow diagram illustrating a method for generating a diversification indicator in accordance with an embodiment of the invention;

FIG. 4A is a flow diagram illustrating a method for optimizing a diversification indicator of a portfolio in accordance with an embodiment of the invention;

FIG. 4B is a flow diagram illustrating a method for generating optimization parameters in accordance with an embodiment of the invention;

FIG. 5A is a plot illustrating asset allocation over time for assets of an example portfolio allocated in accordance with an embodiment of the invention;

FIG. 5B is a plot illustrating a diversification indicator of an example portfolio over time in accordance with an embodiment of the invention;

FIG. 5C is a plot illustrating risk-return profiles of various portfolios compared to a portfolio generated in accordance with an embodiment of the invention;

FIG. 5D is a plot illustrating diversification indicators of various portfolios compared to a portfolio generated in accordance with an embodiment of the invention;

FIG. 6 is a schematic representation of a machine in the exemplary form of a computer system configured to perform one or more of the operations described herein.

### DETAILED DESCRIPTION

Described herein are systems and methods for maximizing portfolio diversification. The diversification of a portfolio may be described by a diversification indicator, which is a quantitative and uniform measure of portfolio-level diversification applied to a multi-asset space. In some embodiments, the diversification indicator is normalized to a range from zero to one, with a value of zero indicating zero diversification benefits in the portfolio, and a value approaching one indicating very high portfolio diversification.

The diversification indicator, as described herein, serves as a well-defined and meaningful measure of diversification. Specifically, when a portfolio allocation is at its most diversified state, the portfolio is equally correlated to every constituent asset of the portfolio, satisfying the property of asset-portfolio correlation (APC) parity. This is meaningful since the portfolio is most diversified when no constituent asset is more or less correlated to the portfolio. Despite wide investor interest in the topic of diversification, to date there existed no uniform, transparent, and quantitative measure of portfolio diversification in the multi-asset space. The embodiments of the present invention address these issues.

In the following description, numerous details are set forth. It will be apparent, however, to one skilled in the art, that the present invention may be practiced without these specific details. In some instances, well-known structures and devices are shown in block diagram form, rather than in detail, in order to highlight the overall prominent concepts and principles of present invention.

Some portions of the detailed descriptions may be presented in terms of algorithms and symbolic representations of operations on data bits within a computer memory. These algorithmic descriptions and representations correspond to the terminology used by those skilled in the data processing arts to most effectively convey the substance of their work to others skilled in the art. An algorithm is here, and generally, used to refer to a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the description that follows, it is appreciated that throughout the description, discussions utilizing terms such as “receiving”, “detecting”, “monitoring”, “generating”, “calculating”, “transmitting”, “enrolling”, “identifying”, “measuring”, “recommending”, “designating”, “increasing”, “issuing”, “processing”, “optimizing”, “maximizing”, “minimizing”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes or it may include a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory devices including universal serial bus (USB) storage devices (e.g., USB key devices) or any type of media suitable for storing electronic instructions, each of which may be coupled to a computer system bus.

The algorithms and displays presented herein are not inherently related to any particular computer or other apparatus. Various general purpose systems may be used with programs in accordance with the teachings herein or it may prove convenient to construct more specialized apparatus to perform the relevant method steps. The structure for a variety of these systems will be apparent from the description that follows. In addition, the present invention is not described with reference to any particular programming language. It will be appreciated that a variety of programming languages may be used to implement the teachings of the invention as described herein.

The present invention may be provided as a computer program product, or software, that may include a machine-readable medium having stored thereon instructions, which may be used to program a computer system (or other electronic devices) to perform a process according to the present invention. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (non-propagating electrical, optical, or acoustical signals), etc.

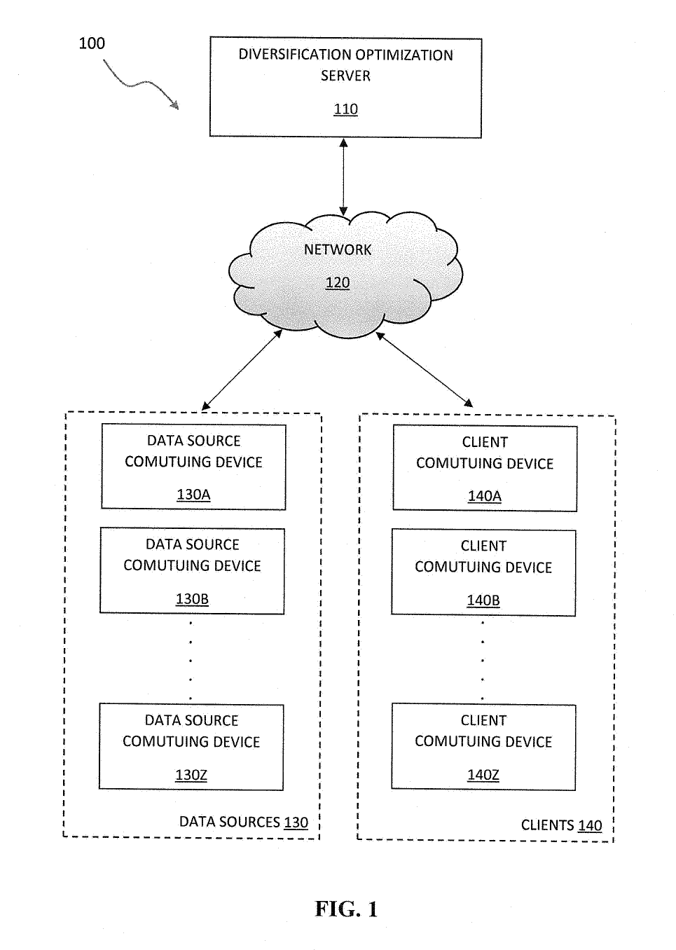

FIG. 1 is a block diagram illustrating an exemplary computer network 100 in which embodiments of the present invention may operate. Referring to FIG. 1, computer network 100 may include a computer-enabled diversification optimization server 110, a plurality of data source computing devices 130A-130Z, which are associated with and collectively referred to herein as data sources 130. Computer network 100 may also include a plurality of client computing devices 140A-140Z, which are associated with and may be collectively referred to herein as clients 140. Diversification optimization server 110 may be communicatively coupled directly or via a communications network 120. Data source computing devices 130A-130Z associated with data sources 130 may be communicatively coupled to communications network 120 via any one of a plurality of communication channels (e.g., e-mail, SMS service, automated voice message, etc.). Similarly, client computing devices 140A-140Z associated with clients 140 may also be communicatively coupled to communications network 120 via any one of the plurality of communication channels. Communications network 120 may be a private network (e.g., a local area network (LAN), wide area network (WAN), intranet, etc.), a public network (e.g., the Internet), a cellular network or any combination thereof.

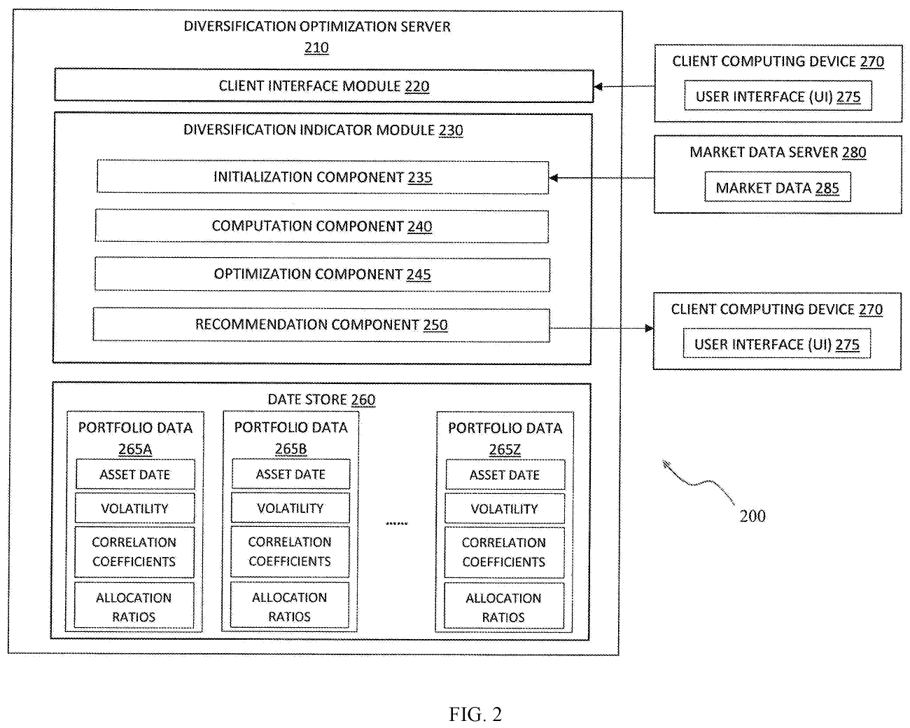

FIG. 2 is a block diagram illustrating an exemplary diversification optimization platform 200 in accordance with an embodiment of the invention. Diversification optimization platform 200 may include a diversification optimization server 210. Diversification optimization server 210 may be the same or similar to, and have the same functionality and connectivity as, diversification optimization server 110 described with respect to FIG. 1. Although diversification optimization server 210 is depicted as a single server, diversification optimization server 210 may be one or more computing devices (e.g., as a rackmount server, a router computer, a server computer, a personal computer, a mainframe computer, a laptop computer, a tablet computer, a desktop computer, etc.), and include one or more data stores (e.g., hard disks, memories, databases), networks, software components, and/or hardware components. In one embodiment, the functionality of diversification optimization platform 200 may be implemented on a client computing device (e.g., client computing device 270) and/or a data source computing device (e.g., market data server 280) in lieu of or in addition to diversification optimization server 210.

Diversification optimization server 210 may include one or more modules configured to generate and optimize a diversification indicator for a portfolio. Diversification optimization server 210 includes client interface module 220, diversification indicator module 230, and data store 260. The diversification indicator module 230 includes an initialization component 235, a computation component 240, an optimization component 245, and a recommendation component 250. More or less modules and components may be included in diversification optimization server 210 without loss of generality. For example, two or more of the modules may be combined into a single module, or one of the modules may be divided into two or more modules. In one implementation, one or more of the modules may reside on different computing devices (e.g., different server computers, on a single client device, distributed among multiple client devices, etc.). In one embodiment, computation component 240 employs mathematical operations to compute diversification indicators, in accordance with the embodiments described herein, as well as relevant parameters. Computation component 240 may also work in conjunction with optimization component 245 to employ numerical methods in determining portfolio parameters that maximize the computed diversification indicator.

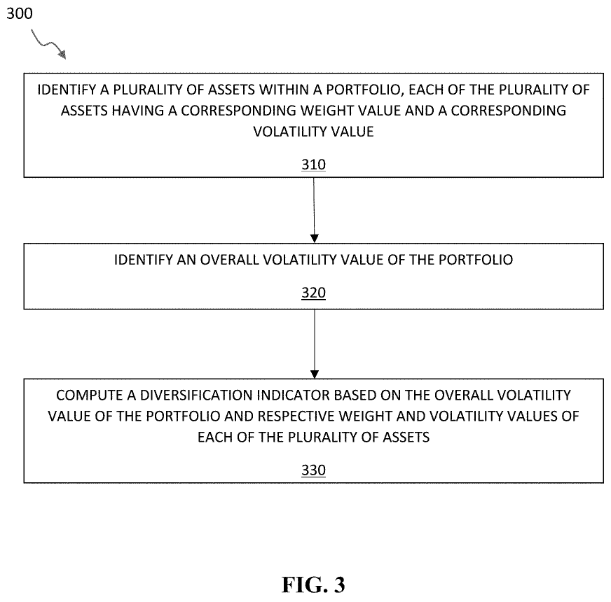

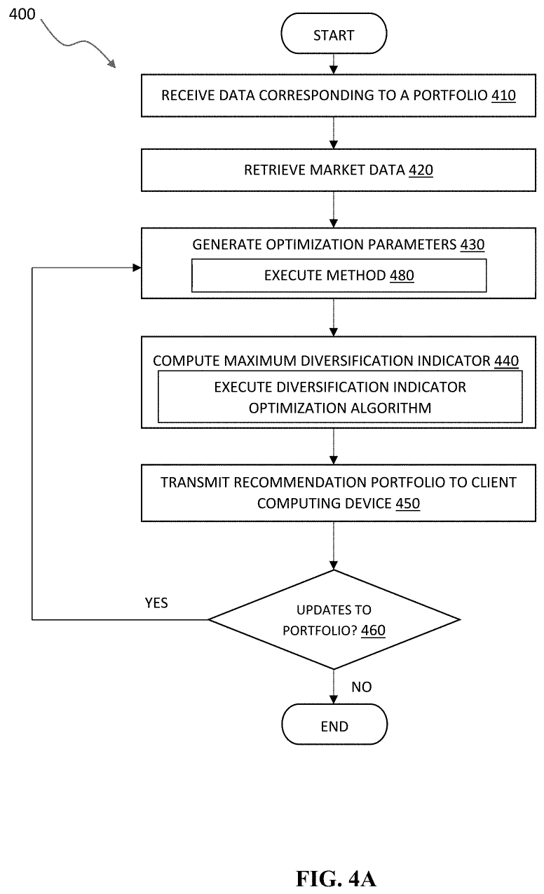

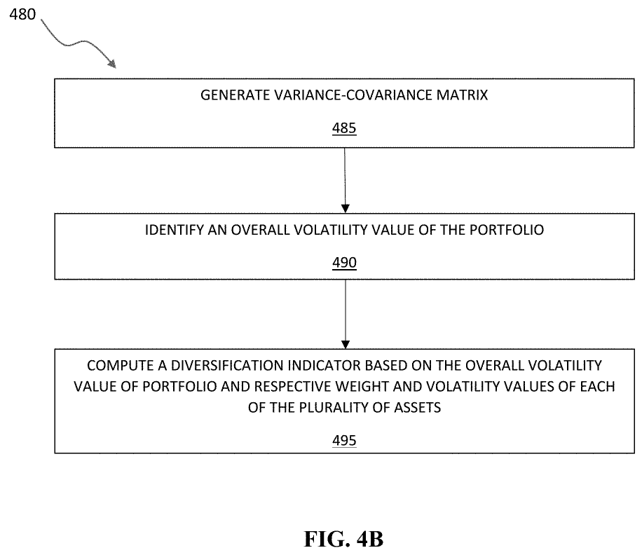

In one embodiment, diversification optimization server 210 may maintain information related to one or more investment portfolios (e.g., which may be stored as portfolio data 265A-265Z in data store 260). An individual investor may be able to access his/her portfolio details from client computing device 270 using UI 275, and may be able view and/or update portfolio parameters using client interface module 220. The parameters may include, but are not limited to, asset data, volatility data, and allocation percentages for each asset. Some or all of these parameters may be provided by the investor directly or may be obtained from one or more data sources (e.g., market data server 280). These parameters are discussed in greater detail below in connection with FIGS. 3 and 4. The stored parameters may be retrieved from data store 260 by diversification indicator module 230 to generate a diversification indicator, determine an optimal diversification indicator (e.g., using a diversification maximization algorithm), and/or generate a recommended investment portfolio for the investor.

In one embodiment, initialization component 235 identifies parameters that may be used in generating a diversification indicator and maximizing a diversification indicator. In one embodiment, initialization component 235 may identify parameters by computing parameters and/or retrieving/receiving one or more parameters from a memory (e.g., data store 260), from client computing device 270 (e.g., by querying client computing device 270 and receiving input from an investor using UI 275), and/or from market data server 280.

In one embodiment, the data store 260 may be a memory (e.g., random access memory), a cache, a drive (e.g., a hard drive), a flash drive, a database system, or another type of component or device capable of storing data. The data store 260 may also include multiple storage components (e.g., multiple drives or multiple databases) that may also span multiple computing devices (e.g., multiple server computers), and may be cloud-based. In some embodiments, the data store 260 may be separate from diversification optimization server 210, and may be, for example, distributed among and accessible to client computing device 270 and market data server 280.

As illustrated in FIGS. 3 and 4, each of methods 300 and 400, respectively, may be performed by processing logic that may include hardware (e.g., circuitry, dedicated logic, programmable logic, microcode, etc.), software (such as instructions run on a processing device), or a combination thereof. In one embodiment, methods 300 and 400 may be performed by one or more processing components associated, respectively, with client interface module 220 and diversification indicator module 230 (which may include one or more of initialization component 235, computation component 240, optimization component 245, or recommendation component 250) of diversification optimization server 210.

FIG. 3 is a flow diagram illustrating a method 300 for generating a diversification indicator in accordance with an embodiment of the invention. In one embodiment, method 300 is executed by diversification indicator module 230 described with respect to FIG. 2. Method 300 may be initiated at block 310, in which a plurality of assets are identified within a portfolio. In one embodiment, each of the plurality of assets may be of a same asset class (e.g., equities, fixed-income, or cash equivalents). In another embodiment, one or more of the plurality of assets may be of different asset classes. For example, a first asset of the plurality of assets may be of a first asset class (e.g., an equity), and a second asset of the plurality of assets may be of a second asset class (e.g., a cash equivalent). Each of the plurality of assets has a corresponding testing weight value (e.g., an associated allocation percentage) and a corresponding volatility value (which may be based on historical market data). All testing weight values sum up to 100% and represent a complete portfolio. The possible weights or allocation percentages of a portfolio are tested to find the optimal portfolio through a diversification optimization server (e.g., diversification optimization server 210). Information associated with the portfolio may have been provided to a diversification optimization server 210 from a client computing device (e.g., client computing device 270) or from another source. The information associated with the portfolio may contain information as to which assets and types of assets are included in the portfolio, a total value of the portfolio, allocation percentage for each of the assets, etc. The information may be stored on a data store (e.g., data store 260) that is accessible to the diversification optimization server. In some embodiments, the plurality of assets are identified by a client computing device.

At block 320, an overall volatility value of the portfolio is identified. The overall volatility value may be computed according to:

σ_{P}=\sqrt{Σᵢ₌₁^{N}Σⱼ₌₁^{N}wᵢwⱼσᵢσⱼρ_{i,j}} (Eq. 1)

where:
σ_{P} is the overall volatility value of the entire portfolio,
the indices i and j range from 1 to N, with N being the number of different assets in the portfolio,
wᵢ or wⱼ is a testing weight value (e.g., an allocation percentage) of a particular asset in the portfolio,
σ₁ or σⱼ is a volatility value of a particular asset in the portfolio, and
ρ_{i,j} is a correlation coefficient between assets i and j, in which ρ_{i,j}=1 when i=j.
Volatility is a statistical measure of the dispersion of returns for a given asset. Volatility can either be measured by using the standard deviation or variance between returns from the asset.
The correlation coefficient is a statistical measure that determines the degree to which two asset returns' movements are associated. The range of values for the correlation coefficient is −1.0 to 1.0.
Volatility data and correlation coefficients may be retrieved from a market data server (e.g., market data server 280). In one embodiment, the overall volatility value is identified by computing the overall volatility value (e.g., using computation component 240), which may be performed by any of the devices described herein (e.g., diversification optimization server 210, client computing device 270, etc.).

At block 330, a diversification indicator is computed based on the overall volatility value and the respective weight and volatility values of each of the plurality of assets (e.g., weight value #1 and volatility value 1 of asset #1, weight value #2 and volatility value #2 of asset #2, etc.), such that the diversification indicator is the ratio of the difference between an asset-weighted volatility and overall volatility value of the entire portfolio, to the asset-weighted volatility. The asset-weighted volatility is calculated as a sum of products, each product being a product of respective weight and volatility values for each of the plurality of assets (e.g., the product of weight value #1 and volatility value #1, the product of weight value #2 and volatility value #2, etc.). The diversification indicator (DI) may be of the form:

$$D I = \frac{{\sum }_{i = 1}^{N} {w}_{i} {σ}_{i} - {σ}_{P}}{{\sum }_{i = 1}^{N} {w}_{i} {σ}_{i}} \qquad ( Eq . 2 )$$

where:
N is the number of different assets in the portfolio,

wᵢ is a testing weight value (e.g., an allocation percentage) of a particular asset in the portfolio,

σᵢ is a volatility value of a particular asset in the portfolio, and
σ_{P} is the overall volatility value of the entire portfolio.

It should be appreciated by one or ordinary skill in the art that block 330 may be executed in different manners. For example, block 330 may be executed after or concurrently with blocks 310 and 320, or may be combined with one or more of blocks 310 and 320. Similarly, block 320 may be performed before block 310 or concurrently with block 310.

As defined by Eq. 2, the diversification indicator includes two parts: a numerator that includes a difference between an asset-weighted volatility and a portfolio volatility, and a denominator that includes the asset-weighted volatility. Accordingly, the diversification indicator will be bounded within a range of 0 to 1, with a value of zero (DI=0) being indicative of zero diversification, that is, when the summation of asset-weighed volatilities is the same as portfolio volatility. When the diversification indicator approaches a value of 1 (DI=1), the portfolio is at its maximum diversification and the portfolio volatility approaches zero. Mathematically, the smaller the overall portfolio volatility (σ_{P}) compared to the undiversified asset weighted volatility (Σᵢ wᵢσᵢ), the larger the numerator becomes as a percent of denominator, resulting in an increased diversification indicator. It is noted that the diversification indicator is not limited to the Eq. 2, as other mathematical definitions may be used to quantify portfolio diversification.

There are several benefits of defining the diversification indicator according to Eq. 2. One benefit is that the diversification indicator can be applied to a heterogeneous portfolio of different assets, that is, the definition is asset class agnostic when it comes to the composition of underlying constituents of the portfolio. Another benefit is that the diversification indicator is uniform on a scale of zero to one, with a value of zero suggesting zero diversification benefit and a value approaching one suggesting maximum diversification. Having both of these features allow for comparison across different portfolios containing heterogeneous assets. Moreover, the diversification indicator has real-world applicability in portfolio construction and planning due to its bounded and asset-agnostic nature. In particular, a set of asset allocation that maximizes the diversification indicator can be identified, thus generating an asset mix with the highest diversification benefit given the underlying assets. Maximization of a diversification indicator may be performed via an optimization process that is discussed below with respect to FIGS. 4A and 4B.

Reference is now made to FIG. 4A. FIG. 4A is a flow diagram illustrating a method 400 for optimizing a diversification indicator of a portfolio in accordance with an embodiment of the invention. Method 400 may be executed, for example, by diversification indicator module 230 described with regard to FIG. 2.

Method 400 may be initiated at block 410, in which data corresponding to a portfolio (referred to as the “current portfolio”) is received. The data may be received from a client computing device (e.g., client computing device 270) by a diversification optimization server (e.g., diversification optimization server 210). For example, an investor may transmit information associated with his/her portfolio (e.g., asset data, allocation data, etc.) using a user interface of the client computing device (e.g., UI 275). In one embodiment, the user may transmit an indication to the diversification optimization server that he/she wishes to have a diversification indicator computed for his/her portfolio and/or receive a recommended portfolio. The diversification optimization server may receive (e.g., using client interface module 220) the portfolio information by retrieving the portfolio information from an internal or external data store (e.g., portfolio data 265A from data store 260 may correspond to the portfolio of the requesting investor). In one embodiment, the diversification optimization server may receive the portfolio data without receiving a communication from a client computing device. For example, the diversification optimization server may receive the data at pre-scheduled times. In some embodiments, the diversification optimization server may be omitted, and at least some of the functionality of the diversification optimization server may be implemented by the client computing device (e.g., diversification indicator module 230 may be implemented on client computing device 270). For example, the client computing device may receive the portfolio information directly via the user interface or from an internal or external data store.

At block 420, market data of constituent asset class returns for the portfolio is retrieved (e.g., market data 285 from market data server 280). For example, the market data may be retrieved by the diversification optimization server from a market data server via a communications network (e.g., communications network 120), and stored (e.g., using data store 260). Market data may include historical returns, risk data, volatility data, etc. The market data may include data for a particular range of time (e.g., from the present to a number of months or years in the past). In one embodiment, market data for multiple assets is retrieved, in which the assets associated with the current portfolio represent a subset of the total assets represented by the retrieved market data. In one embodiment, only market data associated with the assets of the current portfolio is retrieved.

At block 430, optimization parameters are generated. In some embodiments, the optimization parameters may have already been generated, and may have been stored (e.g., using data store 260) for later retrieval. If the optimization parameters have not been generated, or at least some of the optimization parameters have not been generated or are to be updated, method 480 is performed. Once each of the parameters are generated in accordance with method 480, the parameters may be stored for later use (e.g., using data store 260).

Referring now to FIG. 4B, at block 485, a variance-covariance matrix is generated (e.g., as an input for an optimization algorithm). The variance-covariance matrix may be a square matrix having variance values along its diagonal (with each variance value corresponding to a variance of one of the assets of the portfolio), and covariance values in its off-diagonals (corresponding to a correlation between different assets).

In one implementation, an n-by-n variance-covariance matrix for a portfolio of n assets is defined according to:

$$V = [ \begin{matrix}{σ}_{1}^{2} & {ρ}_{1 , 2} {σ}_{1} {σ}_{2} & … & {ρ}_{1 , n} {σ}_{1} {σ}_{n} \\ {ρ}_{2 , 1} {σ}_{2} {σ}_{1} & {σ}_{2}^{2} & … & {ρ}_{2 , n} {σ}_{2} {σ}_{n} \\ … & … & ⋱ & … \\ {ρ}_{n , 1} {σ}_{n} {σ}_{1} & {ρ}_{n , 2} {σ}_{n} {σ}_{2} & … & {σ}_{n}^{2}\end{matrix} ] \qquad ( Eq . 3 )$$

where:
V is a variance-covariance matrix,
σᵢ or σⱼ is a volatility value of a particular asset in the portfolio, and
ρ_{i,j} is a correlation coefficient between assets i and j. The correlation coefficient can be calculated by the computation component 240.

At block 490, an overall volatility value of the portfolio is identified. Block 490 may be performed in a similar manner as described with respect to block 320 of FIG. 3. The overall volatility can be expressed as:

σ_{P}=\sqrt{W′**V*W} (Eq. 4)

where:
W is a set of asset weights, in a N by 1 vector format,

$$[ \begin{matrix}{W}_{1} \\ {W}_{2} \\ … \\ {W}_{N}\end{matrix} ]$$

W′ is the transpose vector of W,
V is the variance-covariance matrix, described in Eq. 3,
* denotes the matrix multiplication.

Referring back to Eq. 2, the denominator of the ratio relates to the diagonal elements, namely, the individual volatilities of the constituent assets, weighted by the allocations, and thus is an undiversified sum of volatilities. The numerator of the ratio considers the magnitude of the diversification by taking the difference between the diagonal elements and the entire covariance matrix, and thus relates to the off-diagonal elements, that is, the correlations of the constituent assets. Empirical evidence suggests that correlations are more important than individual volatilities when examining portfolio diversification.

At block 495, a diversification indicator is computed based on the overall volatility value, respective weight, and volatility values of each of the plurality of assets. In one embodiment, the diversification indicator is the ratio of the difference between an asset-weighted volatility and overall volatility of the portfolio to the asset-weighted volatility. The asset-weighted volatility can be expressed in terms of the weights and variance-covariance matrix according to:

Σᵢ₌₁^{N}wᵢσᵢ=Σᵢ₌₁^{N}wᵢ*sqrt(diagonal elements of V) (Eq. 5)

where:
N is the number of different assets in the portfolio,
wᵢ is a testing weight value (e.g., an allocation percentage) of a particular asset in the portfolio,
σ₁ is a volatility value of a particular asset in the portfolio, and
V is the variance-covariance matrix, described in Eq. 3.

The diversification indicator may be computed in a similar manner as described with respect to block 330 of FIG. 3.

Referring back to FIG. 4A, at block 440, the maximum diversification indicator is identified. The maximum diversification indicator (MDI) may be of the form:

MDI=max(DI) (Eq. 6A)

or

MDI=max(DI−λΣᵢ₌₁^{N}(wᵢ−w₀ᵢ)²) (Eq. 6B)

where:
DI is the diversification indicator of the portfolio computed in accordance with Eq. 2,
wᵢ is a testing weight value (e.g., an allocation percentage) of a particular asset in the portfolio,
w₀ᵢ is an anchoring weight value of a particular asset, and
λ is a factor to balance maximization of DI and penalization of the differences between wᵢ and w₀ᵢ.
In practice, it is often that the investing portfolio need follow an anchoring portfolio. The anchoring portfolio can be a benchmark of a mandate or an investment target or guideline of portfolio managers or investors. Any deviation from the anchoring portfolio should be expected to have a better risk-return outcome (i.e. either higher returns or lower risk or both). For these kinds of investments, the maximization algorithm need have a component that is the penalization due to the deviation from the anchoring portfolio, shown in Eq. 6B.
The MDI may be computed numerically with a diversification maximization algorithm (e.g., using optimization component 245) by any of the devices described herein (e.g., diversification optimization server 210, client computing device 270, etc.). The resulting diversification indicator values lead to the MDI, which is a set of asset allocation percentages that correspond to the maximum diversification of a given portfolio allocation.

At block 450, a recommended portfolio is transmitted to a client computing device (e.g., transmitted from diversification optimization server 210 to client computing device 270 of an investor). The recommended portfolio may include one or more of the MDI for the portfolio or recommended allocation percentages for each of the assets of the portfolio. In one embodiment, the recommended allocation percentages correspond to optimal weight values (e.g., current weight values will be updated by the diversification maximization algorithm to maximize the diversification indicator of the portfolio). For example, the investor may receive at his/her client computing device (e.g., client computing device 270) the recommended allocation percentages corresponding to volatility data determined over a duration of time (e.g., over 6 months, a year, two years, etc.). The recommended portfolio may be presented to the investor with a UI of the client computing device (e.g., UI 275). In one embodiment, data corresponding to other diversification strategies may be transmitted to the client computing device to provide comparisons between the recommended portfolio for varying situations and circumstances. For example, the diversification indicator module may generate one or more diversification indicators corresponding to allocation strategies determined by different portfolio strategies. The data received by the client computing device may generate (e.g., using UI 275) a comparison of the diversification indicators of the other allocations strategies to the diversification indicator of an allocation strategy determined in accordance with the embodiments described herein.

At block 460, a determination is made as to whether updates were or will be made to the portfolio. In one embodiment, a determination may be made as to whether a portfolio of an investor has changed (e.g., whether new assets have been added, assets have been removed, the allocations have been changed, etc.). In one embodiment, the investor may indicate, using the client computing device (e.g., client computing device 270), that he/she wishes to update the parameters associated with the portfolio. The method 300 may then dynamically update stored information associated with the portfolio. In one embodiment, if assets and/or asset classes are added to or removed from the portfolio, method 400 may perform block 430 and 440 (as illustrated in FIG. 4A), in which a new MDI is computed and new optimal allocation percentages are determined (e.g., by diversification indicator module 230). In other embodiments, method 400 may perform one or more of blocks 410, 420, or 430 in any suitable order in response to determining that updates to the portfolio are to be performed at block 460.

In one embodiment, the diversification optimization server may automatically determine whether a new MDI is to be computed. For example, the diversification optimization server may (in addition to the functions described with respect to FIG. 2) provide portfolio maintenance functionality for one or more investors. The diversification optimization server may determine that changes have been made to an investor's portfolio without receiving an indication directly from the investor. As another example, the diversification optimization server may receive updated market data (e.g., from market data server 280), which may serve as an indication to generate a new MDI for one or more portfolios.

If, at block 460, it is determined that the portfolio is not to be updated, method 400 ends, and may repeat continuously. For example, method 400 may be repeated by the diversification optimization server at regularly scheduled intervals, which may correspond to a weekly, bi-weekly, monthly, bi-monthly, etc. schedule, and/or may correspond to times in which updated market data becomes available (e.g., from market data server 280).

It should be noted that the sequence of operations described in conjunction with methods 300, 400, and 480 may be different from that illustrated, respectively, in corresponding FIGS. 3 and 4, while some operations may be omitted without departing from the nature of the embodiments described herein. It should be appreciated by one of ordinary skill in the art that the blocks illustrated in methods 300, 400, and 480 are provided for purposes of illustrating embodiments of the invention and are in no way intended to be limiting in scope.

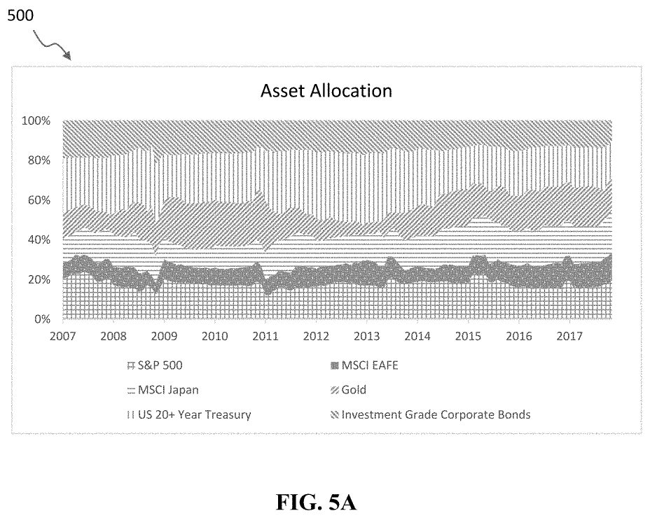

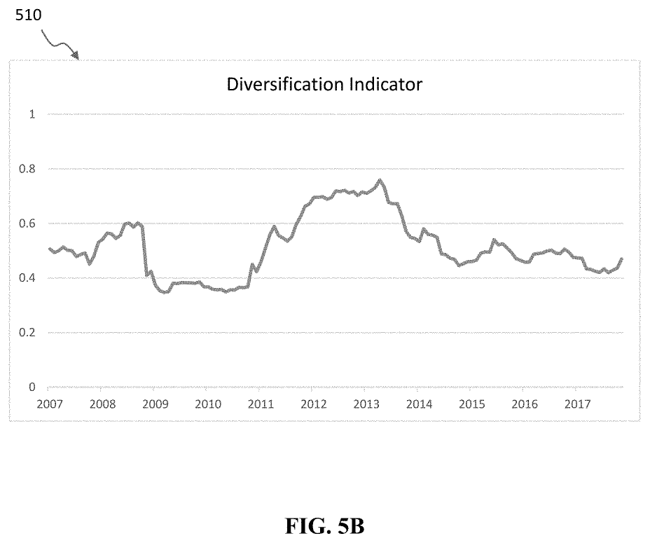

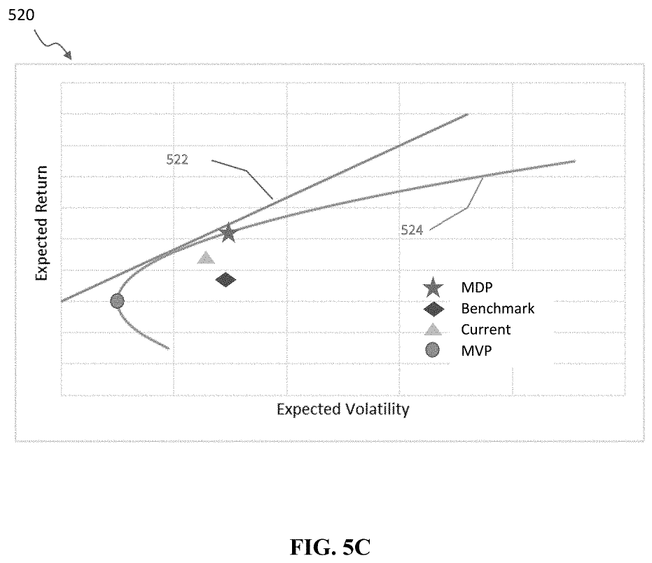

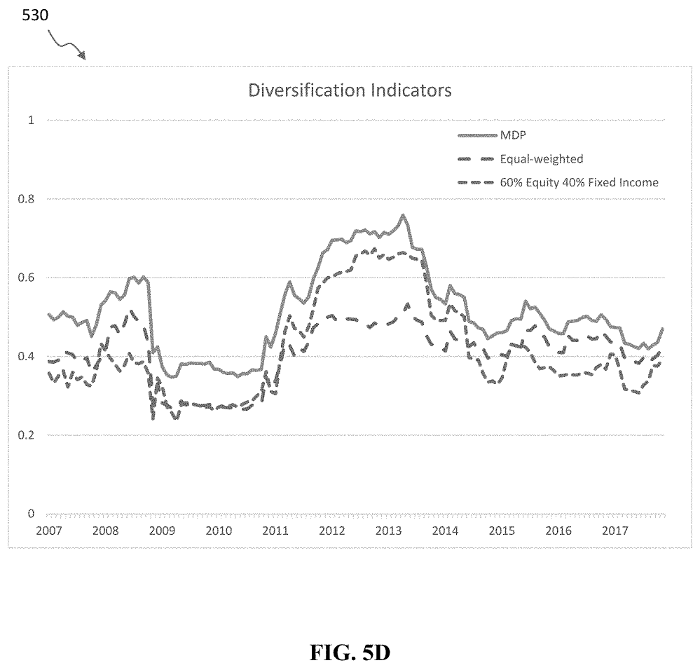

FIG. 5A is a plot 500 illustrating asset allocation over time for assets of an example portfolio allocated in accordance with an embodiment of the invention, and FIG. 5B is a plot 510 illustrating the corresponding diversification indicator for the example portfolio. The example portfolio contains a total of six different assets: S&P 500, MSCI EAFE, MSCI Japan, Gold, US 20+ year Treasury, and Investment Grade Corporate Bond. Each point of plots 500 and 510 correspond to a portfolio for which the asset allocation percentages have been optimized to maximize the diversification indicator, in accordance with an embodiment of the invention. In addition, the parameters used to compute the asset allocation percentages for each point are based on market data averages taken over a two-year period prior to each point. Thus, the fluctuations in the asset allocation percentages over time are due to the changes in returns and risk of the assets over time. Table 1A lists, for a particular point in time (January of 2016), an average returns and volatility values for each asset. Table 1B lists the correlation coefficient values between each asset at the same time point. Table 2 lists elements of a variance-covariance matrix that were estimated based on the same data set. Tables 1A, 1B and 2 correspond to return, volatility, and correlation data estimated over a two-year period (e.g., January of 2014 to December of 2015) prior to January of 2016, however, other periods may be used, such as six months, one year, three years, etc.

TABLE 1A
Input parameters for diversification indicator maximization algorithm: returns and volatility

| | | | | | US 20+ | Investment Grade |
|---|---|---|---|---|---|---|
| | S&P 500 | MSCI EAFE | MSCI Japan | Gold | Year Treasury | Corporate Bonds |
| Annual Return | 7.57% | −2.94% | 2.03% | −5.74% | 11.91% | 3.42% |
| Annualized | 11.21% | 12.55% | 13.35% | 14.39% | 12.08% | 4.73% |
| Volatility | | | | | | |

TABLE 1B
Input parameters for diversification indicator maximization algorithm: correlation coefficients

| | | | | | US 20+ | Investment Grade |
|---|---|---|---|---|---|---|
| | S&P 500 | MSCI EAFE | MSCI Japan | Gold | Year Treasury | Corporate Bonds |
| S&P 500 | 1.0000 | 0.8673 | 0.7092 | −0.1095 | −0.1891 | 0.0702 |
| MSCI EAFE | 0.8673 | 1.0000 | 0.8094 | 0.0389 | −0.1814 | 0.1268 |
| MSCI Japan | 0.7092 | 0.8094 | 1.0000 | −0.0542 | −0.3061 | −0.0754 |
| Gold | −0.1095 | 0.0389 | −0.0542 | 1.0000 | 0.3736 | 0.4308 |
| US 20+ Year | −0.1891 | −0.1814 | −0.3061 | 0.3736 | 1.0000 | 0.9025 |
| Treasury | | | | | | |
| Investment Grade | 0.0702 | 0.1268 | −0.0754 | 0.4308 | 0.9025 | 1.0000 |
| Corporate Bonds | | | | | | |

TABLE 2
Input parameters for diversification indicator maximization algorithm: Variance-Covariance matrix

| | | | | | US 20+ | Investment Grade |
|---|---|---|---|---|---|---|
| | S&P 500 | MSCI EAFE | MSCI Japan | Gold | Year Treasury | Corporate Bonds |
| S&P 500 | 0.001047 | 0.001016 | 0.000884 | −0.000147 | −0.000213 | 0.000031 |
| MSCI EAFE | 0.001016 | 0.001312 | 0.001130 | 0.000059 | −0.000229 | 0.000063 |
| MSCI Japan | 0.000884 | 0.001130 | 0.001485 | −0.000087 | −0.000412 | −0.000040 |
| Gold | −0.000147 | 0.000059 | −0.000087 | 0.001727 | 0.000541 | 0.000244 |
| US 20+ Year | −0.000213 | −0.000229 | −0.000412 | 0.000541 | 0.001217 | 0.000430 |
| Treasury | | | | | | |
| Investment Grade | 0.000031 | 0.000063 | −0.000040 | 0.000244 | 0.000430 | 0.000186 |
| Corporate Bonds | | | | | | |

FIGS. 5C-5D are plots that illustrate various portfolio strategies, including a minimum volatility portfolio (MVP), a current/suboptimal portfolio (e.g. the equal-weighted portfolio), and a benchmark strategy (e.g. 60% MSCI World Equity 40% Global Aggregate Bond portfolio). The minimum volatility portfolio seeks the lowest volatility based on the volatility of each asset and the correlation among assets in a portfolio. The current portfolio is a suboptimal portfolio that investors hold before the optimization by MDI. It can be a straightforward equal-weighted portfolio or a portfolio from last time optimization, but not optimal any more. The 60% MSCI World Equity 40% Global Aggregate Bond portfolio has been a popular multi-asset combination and benchmark in the industry. These strategies are compared against a portfolio generated in accordance with the embodiments described herein, which is hereinafter referred to as a “maximum diversification portfolio (MDP)”.

FIG. 5C is a plot 520 illustrating risk-return profiles of various portfolios compared to a portfolio generated in accordance with an embodiment of the invention. Plot 520 illustrates a capital asset pricing model (CPAM) which assumes that returns are proportional to risk, which includes a capital allocation line 522 and an efficient frontier 524. The capital allocation line 522 contacts the efficient frontier 524 at a tangent point, which indicates an optimal return versus risk. As indicated, the MVP and MDP are along the efficient frontier 524, while the current portfolio or benchmark strategy is not. In contrast with the other strategies, the MDP is not only on the efficient frontier 524, but also maximizes the diversification indicator.

FIG. 5D is a plot 530 illustrating diversification indicators computed according to certain embodiments of the invention for different portfolio strategies. As indicated, the MDP results in a higher diversification indicator than when the diversification indicator is computed for the current and benchmark strategies. Numerically the MDP has higher DI than the current portfolio and benchmark for a long period, which means more favorable on the diversification perspective. At the same time, it proves that the optimization algorithm can be solved and the MDP is practically feasible.

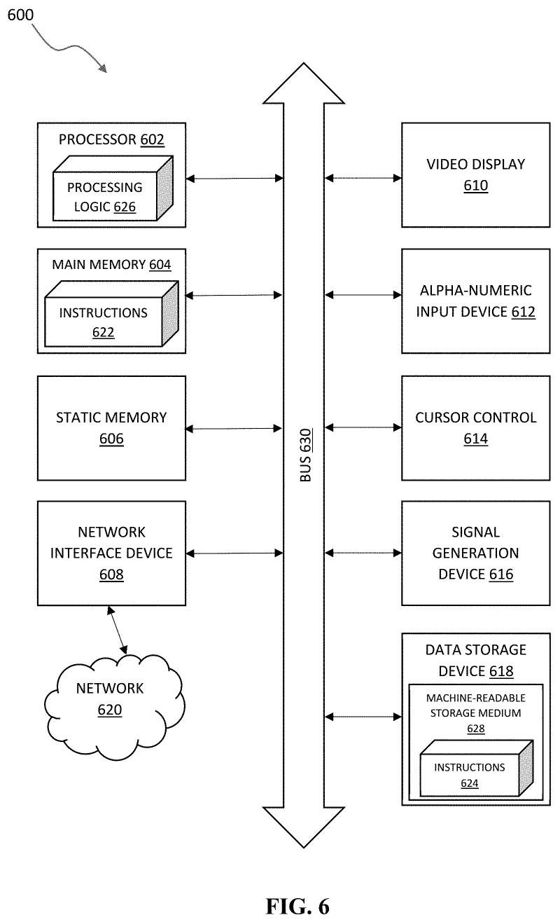

FIG. 6 illustrates a diagrammatic representation of a machine in the exemplary form of a computer system 600 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 may include a processor 602, a main memory 604 (e.g., read-only memory (ROM), flash memory, dynamic random access memory (DRAM) (such as synchronous DRAM (SDRAM) or Rambus DRAM (RDRAM), etc.), a static memory 606 (e.g., flash memory, static random access memory (SRAM), etc.), and a data storage device 618, which communicate with each other via a bus 630.

Processor 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processor 602 may also be one or more special-purpose processing devices such as an application specific integrated circuit (ASIC), a field programmable gate array (FPGA), a digital signal processor (DSP), network processor, or the like. Processor 602 is configured to execute processing logic 626 for performing the operations and steps discussed herein.

Computer system 600 may further include a network interface device 608. Computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 616 (e.g., a speaker).

Data storage device 618 may include a machine-readable storage medium 628 (or more specifically a computer-readable storage medium) having one or more sets of instructions (e.g., software 624) embodying any one or more of the methodologies of functions described herein. For example, software 624 may store instructions to generate a maximum diversification indicator. Software 624 may also reside, completely or at least partially, within main memory 604 and/or within processor 602 during execution thereof by computer system 600; main memory 604 and processor 602 also constituting machine-readable storage media. Software 624 may further be transmitted or received over a network 620 via network interface device 608.

Machine-readable storage medium 628 may also be used to store instructions to generate a maximum diversification indicator. While machine-readable storage medium 628 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing or encoding a set of instruction for execution by the machine and that causes the machine to perform any one or more of the methodologies of the present invention. The term “machine-readable medium” shall also be taken to include, but not be limited to, transitory machine-readable media, including, but not limited to, propagating electrical or electromagnetic signals. The term “machine-readable medium” shall also be taken to include non-transitory machine-readable storage media including, but not limited to, volatile and non-volatile computer memory or storage devices such as a hard disk, solid-state memory, optical media, magnetic media, floppy disk, USB drive, DVD, CD, media cards, register memory, processor caches, random access memory (RAM), etc.

Whereas many alterations and modifications of the present invention will no doubt become apparent to a person of ordinary skill in the art after having read the foregoing description, it is to be understood that any particular embodiment described and shown by way of illustration is in no way intended to be considered limiting. Therefore, references to details of various embodiments are not intended to limit the scope of the claims, which in themselves recite those features regarded as the invention.

What is claimed is:

1. A computer-implemented method, the method comprising:
identifying, by a processing device, a plurality of assets within a portfolio, each of the plurality of assets having a corresponding testing weight value and a corresponding volatility value;
computing, by the processing device, an overall volatility value of the portfolio;
computing, by the processing device, an asset-weighted volatility of the portfolio by a sum of a plurality of products, each of the plurality of products being a product of corresponding weight and volatility values for each of the plurality of assets;
computing, by the processing device, a diversification indicator (DI) based on the overall volatility value and the asset-weighted volatility of the portfolio, wherein the diversification indicator is normalized to be in the range between 0 and 1 by the asset-weighted volatility of the portfolio;
computing, by the processing device, a maximum diversification indicator (MDI) using a diversification maximization algorithm, wherein the MDI is computed based on the diversification indicators based on testing weight values.

2. The method of claim 1, wherein a first asset of the plurality of assets is of a first asset class, and a second asset of the plurality of assets is of a second asset class that is different from the first asset class.

3. The method of claim 1, further comprising:
computing, by the processing device, a variance-covariance matrix based on the corresponding volatility values of each of the plurality of assets, and inter-asset correlations.

4. The method of claim 1, wherein computing the MDI comprises for each of the plurality of assets:
identifying, using the processing device, an optimal weight value corresponding to the MDI; and
updating, using the processing device, the current weight value of the asset with an updated weight value based on the optimal weight value.

5. The method of claim 3, further comprising:
generating, using the processing device, a recommended portfolio based on the updated weight values of each of the plurality of assets; and
transmitting, using the processing device, the recommended portfolio to a client computing device.

6. The method of claim 1, further comprising:
receiving, from a client computing device, data relating to the portfolio prior to identifying the plurality of assets within the portfolio.

7. The method of claim 1, wherein identifying the overall volatility value of the portfolio comprises computing the overall volatility value based on market data associated with each of the plurality of assets.

8. The method of claim 1, wherein the current weight values of each of the plurality of assets are asset allocation percentages either received from a client computing device or from the last optimal weight value.

9. A system comprising:
a memory; and
a processing device communicatively coupled to the memory, wherein the processing device is to:
identify a plurality of assets within a portfolio, each of the plurality of assets having a corresponding testing weight value and a corresponding volatility value;
identify an overall volatility value of the portfolio;
identify an asset-weighted volatility value of the portfolio;
compute a diversification indicator based on the overall volatility value and corresponding weight and volatility values of each of the plurality of assets, wherein the initial diversification indicator is normalized by a sum of a plurality of products, each product of the plurality of products being a product of corresponding weight and volatility values for each of the plurality of assets; and
compute a maximum diversification indicator (MDI), wherein the MDI is computed based on the initial diversification indicator.

10. The system of claim 9, wherein the processing device is further to:
compute a variance-covariance matrix based on the corresponding volatility values of each of the plurality of assets, wherein the MDI is computed based on the variance-covariance matrix and inter-asset correlation.

11. The system of claim 10, wherein the processing device is further to, for each of the plurality of assets:
identify an optimal weight value corresponding to the MDI; and
update the current weight value of the asset with an updated weight value based on the optimal weight value.

12. The system of claim 11, wherein the processing device is further to:
generate a recommended portfolio based on the updated weight values of each of the plurality of assets; and
transmit the recommended portfolio to a client computing device.

13. The system of claim 12, wherein the diversification indicator is bounded between a minimum value and a maximum value.

14. The system of claim 13, wherein the minimum value is 0 and the maximum value is 1.

15. A non-transitory machine-readable medium having instructions encoded thereon, which when executed by a processing device, cause the processing device to perform operations comprising:
identifying, by a processing device, a plurality of assets within a portfolio, each of the plurality of assets having a corresponding testing weight value and a corresponding volatility value;
computing, by the processing device, an overall volatility value of the portfolio;
computing, by the processing device, an asset-weighted volatility of the portfolio by a sum of a plurality of products, each product of the plurality of products being a product of corresponding weight and volatility values for each of the plurality of assets;
computing, by the processing device, an initial diversification indicator (DI) based on the overall volatility value and the asset-weighted volatility of the portfolio, wherein the initial diversification indicator is normalized to be in the range between 0 and 1 by the asset-weighted volatility of the portfolio;
computing, by the processing device, a maximum diversification indicator (MDI) based on the initial diversification indicator.

16. The non-transitory machine-readable medium of claim 15, wherein the operations further comprise:
computing, by the processing device, a variance-covariance matrix based on the corresponding volatility values of each of the plurality of assets and the inter-asset correlation, wherein the MDI is computed based on the variance-covariance matrix.

17. The non-transitory machine-readable medium of claim 16, wherein computing the MDI comprises, for each of the plurality of assets, comprises:
identifying, using the processing device, an optimal weight value corresponding to the MDI; and
updating, using the processing device, the current weight value of the asset with an updated weight value based on the optimal weight value.
